(19) United States
(12) Patent Application Publication
(10) Pub. No.: US 2009/0184065 A1
(43) Pub. Date: Jul. 23, 2009

(54) Dewatering of brine-containing oilfield fluids of uncertain composition

(75) Inventors: Justin L. Cremer, Houston, TX (US); Robert L. Sloan, Katy, TX (US); Kevin W. Smith, Houston, TX (US)

Correspondence Address: William L. Krayer;Attorney at Law, 1771 Helen Drive, Pittsburgh, PA, 15216, US

(73) Assignee: Total Separation Solutions LLC

(21) Appl. No.: 12/221,383

(22) Filed: Aug. 1, 2008

Related U.S. Application Data
(60) Provisional application No. 61/011,634, filed on Jan. 18, 2008.

(51) Int. Cl. C02F 11/12; C02F 101/32; C02F 103/08

(52) U.S. Cl. 210/770

(57) ABSTRACT

Brine-containing oilfield fluid of uncertain composition, such as produced water and used oilfield completion and workover brines, are prepared for transportation and storage by reducing them to very high densities but still with little risk of crystallization at a prescribed temperature. The fluids are densified by boiling at a temperature determined to achieve the desired density, under steady state conditions of input and withdrawal of steam or vapor and the desired concentrate, still without knowing the contstituents. Boiling temperature is significantly reduced under subatmospheric pressures while the desired target density is achieved.

### RELATED APPLICATION

This application incorporates in its entirety and claims the full benefit of Provisional Application 61/011634 filed Jan. 18, 2008, titled “Controlled Dewatering of Dense Brines of Uncertain Composition.”

### TECHNICAL FIELD

Free water in aqueous oilfield fluids of uncertain composition is reduced to within a desired minimal percentage so the fluids may be transported or stored at ambient or controlled temperatures, with little risk of crystallization. Valuable components of the fluids may be conserved if desired. For the fluid of unknown composition, boiling conditions are determined and stabilized to remove water to achieve a fluid of very high density and minimal water content. Boiling is conducted advantageously at subatmospheric pressures.

### BACKGROUND OF THE INVENTION

Dense, clear completion and workover fluids have been used for decades in oil and gas production. See, for example, Sanders U.S. Pat. No. 4,292,183 and Stauffer et al U.S. Pat. No. 4,304,677, both of which disclose early uses of various combinations of zinc bromide and calcium bromide as principal ingredients. In practice, such brines commonly include calcium chloride also. Typical densities of such brines are in the range of 14 to 20 pounds per gallon. The high density of such brines is especially beneficial where high pressures are expected or in unusually shallow reservoirs, but the cost of providing them, as well as the difficulty of disposing of them, has limited their use. An excellent response to both of these negatives is to find an efficient way to recycle the brines.

In almost all cases, it is, or would be, beneficial to recover a used clear dense brine and store it for reuse. Oil well service companies may offer to do so, but the service is complicated not only by the sheer weight of the fluid, but also by uncertainty as to the composition of a used fluid, exacerbating the risk that it will crystallize in transport or storage, which would require great expense to redissolve or otherwise recover the material.

Data showing the relationship between density and temperature of calcium/zinc bromide solutions is presented in Table V of the above cited Sanders patent—as the temperature is decreased from 230 to 77° F., the density increases for each of five solutions of varying ratios of zinc bromide to calcium bromide. In the above-cited Stauffer et al patent, the inventors achieve desired densities by using various ratios of calcium and zinc bromides, but the crystallization points are significantly different in each example. Rough correlations of density to crystallization temperatures are shown by House, in U.S. Pat. No. 4,435,564—in zinc and calcium bromide and, optionally, chloride, brines, the crystallization temperature increases as the density increases. Thus, where the objective is to remove as much water as possible before transporting the brine, it would seem that the danger of crystallization increases as the density increases. In practice, however, because of the various combinations and concentrations of calcium chloride, calcium bromide, and zinc bromide commonly used in oilfield fluids, there is no reliable correlation between the density of an unknown composition at a given temperature and its crystallization temperature. The term “crystallization point” is also used in the art, and this may include pressure as a variable as well as temperature and density. A crystallization point for a brine—the point at which the brine crystallizes—represents a convergence of factors such as the pressure, temperature, density, and constituents of the brine.

As implied in its terms, a highly dense brine contains a large amount of dissolved salts, which means the amount of water present is small compared to a brine which is not so dense. The relatively small amount of water in a highly dense brine tends to distort pH readings, as reported by Thomas, in U.S. Pat. No. 4,836,941. In one example, a calcium bromide/zinc bromide brine having a density of 19.3 had a measured pH of 1.1, but when diluted 1:10, the same brine had a pH of 5.6. Other measurements, including measurements of free water, can also be distorted or rendered questionable by the high ratios of salts to water in the dense brines, making any process for minimizing free water in such a brine difficult to control.

Water produced from the earth in the course of hydrocarbon production is known generally as “produced water.” It may be separated from the from the recovered hydrocarbons, or may arrive at the wellhead more or less by itself, free of hydrocarbons, or may be a product of an injection process, in which a fluid is pumped down an injection well usually to force hydrocarbons from the formation to a different well. In any of these cases, the aqueous solution or slurry, primarily or entirely of connate origin, commonly contains not only sodium and/or calcium cations but also carbonate and/or sulfate anions as well as chlorides—combinations highly likely to form scale under one or more of the conditions they are likely to encounter as they are handled for temporary storage and disposal. Disposal of produced water is increasingly difficult for the operators, in that re-injecting it may not be permissible under environmental regulations, and transportation to a distant approved disposal site may be quite expensive,

The cost of transportation is generally a function of weight, and water is a major portion of produced water. Whether or not the produced water has high concentrations of scale-forming salts, the operator would benefit from a reduction in its sheer quantity.

It is desirable to transport as little water as possible, and accordingly a significant problem has been how to minimize the water in produced water of a used brine of uncertain composition without approaching too closely its crystallization point for a prescribed temperature, or otherwise defeating the objectives of the process.

### SUMMARY OF THE INVENTION

We have invented a process for controlled dewatering of dense brines and produced water. The process is applicable to and especially useful for clear completion and workover brines which have been used in treating wells in oil and gas recovery, and to produced water which must be transported for disposal.

The term “dense well treatment brine” or “clear dense well treatment brine” as used herein means a brine comprising calcium bromide and zinc bromide, and optionally calcium chloride, but otherwise of uncertain composition; salts other than bromides and chlorides of zinc and calcium are rare. Ratios of zinc bromide to calcium bromide may commonly vary from 80:20 to 20:80, although ratios outside this range are sometime used, and occasionally the brine will be entirely one or the other bromide, in any case with or without a smaller amount of calcium chloride. Densities will range from 14 to 20 pounds per gallon. The atmospheric boiling points of used dense well treatment brines may vary from 245° F. to 345° F. or even as wide as 213° F. to 370° F. Persons skilled in the art will realize that, as a dense brine is boiled and it becomes even more dense, its boiling point will also increase. The rate of boiling point increase as a function of density is difficult to predict, however, without knowing the constituents of the brine.

The term “produced water” as used herein includes but is not limited to connate water, having widely varying compositions and atmospheric boiling points from 213° F. to 370° F. As is known in the art, connate water commonly contains not only chlorides but also calcium carbonate and/or sulfate, frequently in high percentages, making it environmentally suspect for disposal in spite of its natural origin. While produced water is frequently entirely connate water, we do not intend to rule out the possible presence of other aqueous solutions or slurries from human activities, such as hydrocarbon production operations, that might be commingled with the connate water. We include such mixtures in the term “produced water.” Such aqueous materials are also of uncertain composition. Skilled operators are quite aware of the particular handling problems presented by highly calciferous, high sulfate, and rapidly scale-forming characteristics of produced water.

Our invention is useful to reduce the weight and volume of both clean used well treatment brines and produced water, both of which are of unknown, or at least uncertain, composition. Whether the ultimate objective is to dispose of the concentrated fluid or to re-use it, the process of our invention is similar. We use the term “brine-containing oilfield fluid” and/or “brine-containing oilfield fluid of uncertain composition” to include both used dense well treatment brines and produced water, as both aqueous fluids will be treated in our invention to reduce their bulk by removing as much water as may be safely removed so that the fluid can be stored or, especially, transported, still in liquid form as inexpensively as possible. By “safely” and “as inexpensively as possible” we do not mean to imply absolutes; there is a range of percentages of free water which is to be left in the fluid to anticipate the vagaries and vicissitudes of temperatures and other factors during transport and storage. The brine-containing oilfield fluid treated in our invention will have atmospheric boiling points of 213° F. to 370° F.

We have developed a practical procedure for processing brine-containing oilfield fluid to achieve a highly dense fluid for which the risk of crystallization is low, so that it may be transported and stored for future use without undue concern about its becoming completely solid.

Generally, our invention is a method of dewatering a brine-containing oilfield fluid of uncertain composition to minimize the amount of free water in it while maintaining the fluid in a liquid state, the fluid having an original atmospheric boiling point between 213° F. and 370° F., comprising boiling water from the fluid to concentrate the fluid in a vessel, thereby increasing its density and achieving a new atmospheric boiling point for the fluid from 10 to 60 degrees F. higher than the original atmospheric boiling point, and continuously boiling the fluid while continuously withdrawing vapor or steam from the vessel, continuously withdrawing the concentrated fluid from the vessel, and continuously feeding the brine-containing oilfield fluid to the vessel to maintain a substantially constant volume of the fluid in the vessel. The steady state boiling conditions are desirably maintained at subatmospheric pressures which permit using temperatures substantially lower than the atmospheric boiling temperature to maintain the fluid at a density useful for achieving a prescribed crystallization point. Particularly for the sake of safety, the subatmospheric pressure will enable a temperature considerably lower than the atmospheric boiling point of the enhanced-density fluid, desirably at least 50° F. lower, at least 75° F. lower, or as much as 100° F. lower or even more. Thus, while the atmospheric boiling temperatures will reach 10 to 60° F. higher as the oilfield fluid densities, we normally conduct the boiling at points significantly lower than the original boiling point.

In one aspect of the invention, the concentrated fluid product comprises about 1.5% to about 4% by weight free water. The original aqueous fluid may be preheated in a more or less conventional heat exchanger with either (or both) the withdrawn densified fluid or the withdrawn vapor or steam, which can accordingly be condensed in the process, yielding a clean water condensate product. The evaporation process may be supplemented or combined with other means for evaporating.

### BRIEF DESCRIPTION OF THE DRAWINGS

FIG. 1 is a flow sheet of an efficient process of our invention.

FIG. 2 illustrates some possible variations in our invention.

### DETAILED DESCRIPTION OF THE INVENTION

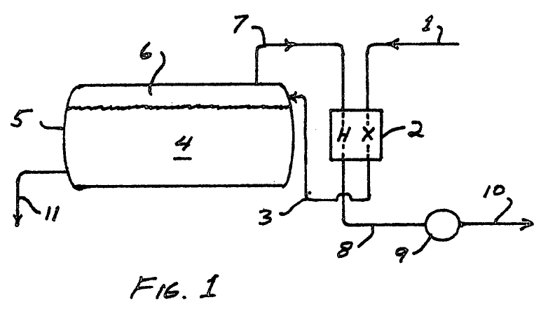

Referring now to FIG. 1, incoming aqueous brine-containing oilfield fluid is taken by conduit 1 through heat exchanger 2where it picks up heat as discussed below. The warmed fluid is conducted in line 3 to boiler vessel 5, where the fluid 4 is boiled, obtaining heat from a source not shown. Steam and vapor in overhead space 6 is conducted through line 7 to heat exchanger 2, where it gives up a portion of its thermal energy to the incoming fluid in line 1, and continues through line 8 to a vacuum pump 9, which draws a vacuum on the lines 8 and 7 and hence the vessel 5 also. While the brine-containing oilfield fluid is continuously brought into the vessel 5 through line 3, vapor and steam are removed in line 7, and the boiling of the fluid is controlled to maintain the fluid at boiling in the subatmospheric conditions within the vessel 5. The desired further densified fluid is continuously withdrawn from vessel 5 through line 11.

An additional outlet for the heated and concentrated fluid 4 may be provided to send a portion of it to a supplemental evaporation device such as a separate vacuum-induced evaporator; fluid further concentrated in such a supplemental evaporation device may be returned to boiler vessel 5.

The process will work without drawing a vacuum. That is, the dense fluid in the vessel can be boiled substantially continuously and steady state conditions can be maintained by regulating the heat input, the brine-containing oilfield fluid input, the steam/vapor output, and withdrawal of the desired denser fluid. Because of the high atmospheric boiling temperatures of the highly dense fluids obtained, however, the operator may prefer to conduct the boiling process at subatmospheric pressures.

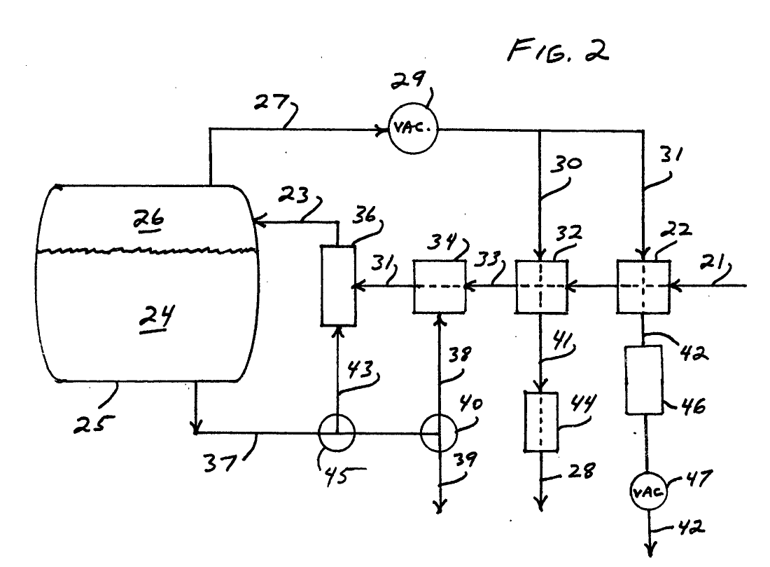

It is known that when water is removed from a dense brine by boiling, its density not only increases, but its boiling temperature will increase also as a function of the density, at a rate also dependent, however, on the makeup of the brine, which in our case is unknown. The atmospheric boiling temperature of a brine or other high solute-containing fluid having a very low free water content may be 300° F., for example, or higher. If one continues to boil off water, eventually all the free water will be driven off, which is highly undesirable. If a brine has a boiling point of 315° F. at its desired maximum density, for example, one could maintain the vessel 5 at a temperature of 310° F., for example, while also maintaining other steady state conditions. This would mean, however, that the incoming stream of dense well treatment brine would have to be heated continuously to that temperature, requiring significant heat input to reach the boiling point, and would mean also that operating the vessel would present increased hazards. Accordingly, we provide vacuum pump 9 on line 8. By applying vacuum in lines 7 and 8, the temperature in vessel 5 may be significantly lower than 310° F. (following the same example) and still maintain the steady state conditions of flow and thermal energy inputs, and steam/vapor and concentrated brine outputs. Desirably the boiling temperature under a subatmospheric pressure in vessel 5 will be at least 100° F. lower than the original atmospheric boiling point of the brine. The steam and vapor in line 8 may be partly or completely condensed in heat exchanger 2, but may be completely condensed in line 10 or in a condenser placed similar to condenser 46 in FIG. 2, which could serve as an additional source of heat for incoming fluid; the condensed water in line 10 provides a source of clean water which could be used for various purposes.

We first determine the density for the desired concentrated brine-containing oilfield fluid—that is, for a densified fluid having a prescribed crystallization temperature. This may be done empirically by taking one or more samples of the brine-containing oilfield fluid and boiling them, removing water to form samples of significantly higher densities and significantly higher atmospheric boiling temperatures. We cool the one or more densified samples to temperatures near the given crystallization temperature and select a density slightly below the density corresponding to the given crystallization temperature as determined by observing whether or when the samples begin to crystallize. The density of that densified fluid sample is then used to determine the process density or the target density. In determining the process or target density, allowance may be made for an anticipated increase in density as the concentrated product brine is cooled to ambient temperatures. Other empirical methods of deciding upon a target density could include boiling such samples under subatmospheric pressure to increase their densities and then testing for crystallization. By empirically determining, we mean making a rough judgment based on a trial and error procedure and/or a systematic sampling routine designed to bracket the crystallization end point on which to base the selection of the target density.

The heat exchanger 2 is not essential to the process, but contributes to its practicality. Any convenient or conventional heat exchanger may be used. For example, the incoming brine-containing oilfield fluid may be sprayed over a coil containing the vapor or steam in line 7, and collected for further transport to vessel 5. This has the advantage that if the coil scales, the scale may be conveniently removed. Heat exchanger 2 may be filled with a fluid capable of removing it from a heated line 7 and transferring it to a cooler conduit 1. Heat exchanger 2 may itself be part of line 7 or conduit 1 and the other passes through it or around it. A heat exchanger may also be provided to transfer heat from concentrate line 11 to incoming line 1 or 3. In addition to or instead of a heat exchanger, the brine-containing oilfield fluid may be heated by any conventional heating means. Or, it could be heated in a cavitation device such as described in U.S. Pat. Nos. 5,385,298, 5,957,122 6,627,784 and particularly 5,188,090. See Smith and Sloan U.S. Pat. No. 7,201,225, which extols the scale-free heating capabilities of cavitation devices. A cavitation device heats a fluid by causing small violent implosions within the fluid itself, generating heat without using a heat transfer surface and thus obviating the significant scale-forming tendencies of highly dense brines and calciferous produced water. The fluid withdrawn from the vessel in line 11 may also be used to preheat the incoming brine-containing oilfield fluid, in a heat exchanger of any convenient type.

In some cases, it may be advantageous to pretreat the brine-containing oilfield fluid to precipitate or otherwise remove at least a portion of the scale-forming salts in it.

One may monitor and/or control the process by continuously or intermittently measuring or monitoring the free water content of the brine-containing oilfield fluid, the density of the brine-containing oilfield fluid, the conductivity of the brine-containing oilfield fluid, the temperature of the brine-containing oilfield fluid, pressures within the vessel, flow rates of the incoming and outgoing fluids, production of clean water condensed from output steam or vapor, and other factors of possible interest to the operator, including the crystallization temperature of the product concentrated brine. Continuous or intermittent monitoring and control of such conditions and variables may permit a density in the vessel 5 even higher than necessary for the density at the prescribed crystallization point at a lower temperature; in this case the operator may wish to dilute the concentrated brine in line 11 to the appropriate density slightly below that required for the prescribed crystallization point. An important variable in any case will be the negative pressure (the vacuum) drawn on the vessel through the vapor/steam line 7, as this will have a direct effect on the temperature necessary to boil and remove water from the brine in the vessel. Other set points, valves, transducers, and control devices will be utilized to maintain the steady-state conditions useful for efficient operation. Where the boiling temperature is, for example, 200° F. because of the applied vacuum, the operation of the vessel may be considerable less hazardous than if it were at 300° F., and the flows, temperatures and pressures will be controlled accordingly by known means.

FIG. 2 illustrates some variations and options that can be used in our invention. Here, the incoming brine-containing oilfield fluid passes through line 21 to a heat exchanger 22 where it picks up heat and proceeds to heat exchanger 32 to pick up additional heat, through line 33 to yet another heat exchanger 34 before it arrives at the cavitation device 36. Again, the operator may wish to consider a precipitation or other pretreatment of the brine-containing oilfield fluid to ameliorate its scale-forming tendencies on the heat exchange surfaces, although the cavitation device tends to be scale-free. Any conventional such pretreatment may be used. Cavitation device 36 contributes considerably more heat energy before the fluid passes through line 23 to boiler vessel 25, similar to boiler vessel 5 of FIG. 1. In boiler vessel 25, the fluid 24 may be further heated by any conventional means not shown. A vacuum pump 29 draws off vapor and steam from overhead space 26 through line 27 and passes it through lines 30 and 31 to heat exchangers 32 and 22, where it gives up heat to the incoming brine-containing oilfield fluid. The vapor or steam in line 30 is seen passing from line 41 at a lower temperature to condenser 44, which enables line 28 to pass clean condensate water to storage or a separate useful purpose. The steam or vapor in line 31 is also cooled by passing through heat exchanger 22, which is optional. An optional condenser 46 is also shown in line 42, downstream of which is vacuum pump 47. As the steady state conditions are established and maintained, fluid having the desired density may be withdrawn through lines 37l and 39 and sent to an appropriate container for shipment or storage. This material, being highly dense and containing only a small amount of free water, may be transported much more inexpensively than the incoming brine-containing oilfield fluid. Optionally, most often during the period during which the temperature of the fluid 24 is increasing to the desired boiling point, fluid in line 37 can be recycled through line 43 to the cavitation device 36 or can even be shunted first by way of valves 45 and 40 through line 38 to heat exchanger 34 and then to the cavitation device 36 for further heat input.

Persons skilled in the art of energy conservation will recognize that the configurations illustrated in FIGS. 1 and 2 are somewhat discretionary and that the design and disposition of the heat exchangers, condensers and vacuum pumps may be varied. Any suitable heat exchangers may be used to conserve the heat energy in both the vapor/steam removed in line 27 and the concentrated fluid product in line 37. Both streams will ultimately be cooled in one way or another, and heat given off in the cooling process can be used for heating the incoming brine-containing oilfield fluid. A vacuum pump will be generally more efficient in our process when it is downstream of a condenser, and a condenser may operate better downstream of a heat exchanger, but the system should be engineered with the overall objective in mind to reduce the volume of brine-containing fluid in the most efficient manner. Use of a cavitation device for heating is not essential, but we have found that its ability to heat without a scale-forming surface is highly beneficial for treating the high-salt solutions of brine-containing oilfield fluids. One or more vacuum pumps may be placed in any part of the system where it or they can exert a vacuum on the boiler vessel 25.

### EXAMPLE 1

### Determination of End Points for Density, Atmospheric Boiling Point, and Crystallization Temperature

Samples from six large batches of used brines were numbered 1-6, and analyzed as shown in Table 1:

TABLE 1

| Batch | Density | NTU¹ | pH | Iron² | FCTA³ | TCT⁴ | IBP⁵ |
|---|---|---|---|---|---|---|---|
| 1 | 14.37 | 2.39 | 5.11 | 20 | <−20 | — | 247 |
| 2 | 14.86 | 2.09 | 5.34 | 20 | 19 | 34 | 270 |
| 3 | 14.38 | 3.65 | 5.14 | 25 | <−18 | — | 248 |
| 4 | 14.08 | 135 | 5.43 | 50 | 14 | 19 | 260 |
| 5 | 14.63 | 2.84 | 5.05 | 40 | −16 | −8 | 263 |
| 6 | 14.28 | 11.3 | 4.87 | 20 | <−16 | — | 248 |

¹NTU = nephalometric turbidity units.
²Elemental Iron in ppm.
³FCTA = first crystal to appear (temperature in degrees F).
⁴TCT = true crystallization temperature, degrees F.
⁵IBP = initial boiling point, degrees F.

Three samples each of the brines were taken and boiled to increase their densities to target densities, then cooled to observe their FCTA's; then a “working density” for each was determined, as shown in Table 2:

TABLE 2

| Original Batch | New Densities | Working Density |
|---|---|---|
| 1 | 16 16.5 17 | 16 |
| 2 | 15.5 16 16.5 | 16.5 |
| 3 | 15.5 16 16.5 | 15.5 |
| 4 | 15 15.5 16 | 15.5 |
| 5 | 16 16.5 17 | 16 |
| 6 | 15.5 16 16.5 | 16 |

The Working Density is an interim optimum based on the crystallization temperature results. Samples from each batch that attained the working density were filtered and rechecked for physical properties, with the results shown in Table 3:

TABLE 3

| Sample | Density | NTU | pH | Iron | FCTA | TCT |
|---|---|---|---|---|---|---|
| 1-1 | 15.9 | 2.54 | 5.13 | 15 | 13 | 27 |
| 2-3 | 16.13 | 3.37 | 4.81 | 20 | 21 | 36 |
| 3-1 | 15.38 | 0.69 | 4.89 | 10 | 0 | 7 |
| 4-2 | 15.33 | 10.9 | 5.03 | 15 | 38 | 48 |
| 5-1 | 15.76 | 2.1 | 4.8 | 35 | 22 | 34 |
| 6-2 | 15.97 | 1.12 | 5.08 | 15 | 26 | 39 |

The TCT is designated the prescribed crystallization temperature in each case. Based on these results, each of the working densities was confirmed as a target density for its corresponding batch. However, it should be understood that the target density TD is not an absolute or precise value; the operator may adopt a range of densities, based on the target density, as satisfactory for his purposes, and such a range is contemplated in our invention as part of the definition of target density TD.

Boiling a separate sample of one of these, Sample 2-3, is illustrated in the following Table 4. Only a negligible amount of evaporation was observed during the increase in temperature up to about 275° F. Thereafter, as the temperature was increased to maintain a continuous boiling state, the specific gravity and density increased at substantially linear rates while the volume and mass were reduced because of steam formation and removal. When the density reached 16.5, the working density was designated the target density, and no further increase in temperature was imposed. That is, a temperature of 305° F. was determined to be the optimum atmospheric boiling temperature for this brine in order to achieve the prescribed crystallization temperature of 36° F. This brine could be fed into a vessel such as boiler vessel 5 in FIG. 1, heated to a temperature of 305° F., and maintained at approximately that temperature by substantially continuously introducing the same brine through lines 1 and 3, removing steam through line 7, and removing concentrated brine through line 11, all at rates controlled to maintain the brine 4 at about 305° F. Heat may be more or less continually introduced by any conventional means. The incoming brine may be preheated also.

TABLE 4

| | Meas. | | Spec. | | |
|---|---|---|---|---|---|
| Temp (deg F.) | Mass | Mass (g) | Grav. | Density | Volume |
| Ambient | 728.5 | 534.9 | 1.783 | 14.88 | 300.0 |
| 240.0 | 727.4 | 533.8 | 1.786 | 14.90 | 298.9 |
| 245.0 | 727.2 | 533.6 | 1.786 | 14.91 | 298.7 |
| 250.0 | 727.0 | 533.4 | 1.787 | 14.91 | 298.5 |
| 255.0 | 726.7 | 533.1 | 1.788 | 14.92 | 298.2 |
| 260.0 | 726.1 | 532.5 | 1.789 | 14.93 | 297.6 |
| 265.0 | 725.8 | 532.2 | 1.790 | 14.94 | 297.3 |
| 270.0 | 725.2 | 531.6 | 1.792 | 14.95 | 296.7 |
| 275.0 | 724.5 | 530.9 | 1.794 | 14.97 | 296.0 |
| 280.0 | 716.9 | 523.3 | 1.814 | 15.14 | 288.4 |
| 285.0 | 705.3 | 511.7 | 1.849 | 15.43 | 276.8 |
| 290.0 | 693.9 | 500.3 | 1.885 | 15.73 | 265.4 |
| 295.0 | 687.3 | 493.7 | 1.908 | 15.92 | 258.8 |
| 300.0 | 677.2 | 483.6 | 1.945 | 16.23 | 248.7 |
| 305.0 | 668.2 | 474.6 | 1.980 | 16.52 | 239.7 |

| | |
|---|---|
| liquid, no crystals | Good |

Because of the tendency of brines and other oilfield liquids to form scale, a highly effective way to heat the incoming brine-containing oilfield fluid in line 1 or 7 is with a cavitation device as mentioned above, such as those manufactured and sold by Hydro Dynamics, Inc., of Rome, Georgia, most relevantly the devices described in U.S. Pat. Nos. 5,385,298, 5,957,122 6,627,784 and particularly 5,188,090, all of which are hereby specifically incorporated herein by reference in their entireties. The reader may also be interested in reviewing Smith and Sloan U.S. Pat. No. 7,201,225, which describes the conservation of components in oilfield brines using a cavitation device. Any conventional temperature monitor or transducer may be used in the brine 4 with appropriate controls to maintain its temperature in a substantially steady state, whether or not the boiler vessel 5 is held at subatmospheric temperature.

As indicated above, there is a substantially linear relationship between the temperatures of the boiling brine beginning at about 275° F. to the end point of 305° F., and the densities from about 14.97 to 16.52. Such a linear relationship will be generally observed for all brine-containing oilfield fluids treated within our invention, but the ratios will vary from fluid to fluid. The ratio of density to boiling temperature in the range of 275 degrees to 305 degrees, as in Table 4, is 0.0516. Ratios of density to boiling temperature at and above the initial boiling point for all six of the brines are shown in Table 5:

TABLE 5

| Brine | Boiling Range, ° F. | Density Range | Ratio, D/T |
|---|---|---|---|
| 1 | 250-298 | 14.46-17.09 | 0.0548 |
| 2 | 275-305 | 14.97-16.52 | 0.0516 |
| 3 | 255-289 | 14.59-16.61 | 0.0594 |
| 4 | 265-297 | 14.20-16.02 | 0.0569 |
| 5 | 265-290 | 14.72-16.03 | 0.0524 |
| 6 | 250-288 | 14.38-16.54 | 0.0568 |

Persons skilled in the art will recognize that the rate of increase of density with an increase in boiling temperature, while being substantially linear in each case, varies considerably from brine to brine. Further, there is no reliable correlation between the rate of density increase and/or boiling temperature increase with the composition of a brine. Brines of quite dissimilar compositions may have similar rates of increase. Because of the considerable differences in composition among used oilfield brines and produced waters, we have found it more useful to determine the desired density and boiling temperature correlated with a target crystallization temperature for a given brine of unknown composition by our method than to attempt any method of predicting them from an analysis of the composition of the brine, which in any case can be quite problematical because of foreign materials, precipitation of compounds of unknown composition, and the like, not to mention the burden of analyzing for even the more common constituents such as chloride, bromide, carbonate, sulfate, zinc, sodium, potassium, calcium, barium and cesium.

When operating the system at subatmospheric pressures, the objective is to reduce the boiling temperature in the boiling vessel 5, thus rendering the entire operation safer and easier to handle with a reduced thermal energy input. While the operator may wish to correlate a particular subatmospheric pressure with a steady-state operating temperature, it is necessary only to monitor and control the density of the boiling brine while assuring that the brine continues to boil. Suitable density meters can provide continuous input to an appropriate controller for this purpose.

Our invention is thus seen to include a method of dewatering a brine-containing oilfield fluid of uncertain composition to obtain a densified fluid having a prescribed crystallization temperature, the brine-containing oilfield fluid having an original atmospheric boiling point between 213° F. and 370° F., comprising
(a) empirically determining a target density for the densified fluid,
(b) boiling an initial quantity of the brine-containing oilfield fluid in a vessel at a subatmospheric pressure until the brine-containing oilfield fluid achieves the target density, and

(c) thereafter maintaining substantially steady state temperature and a substantially steady state subatmospheric pressure in the vessel while also maintaining substantially steady state inflow of the brine-containing oilfield fluid and outflow of

(i) steam or vapor and (ii) densified fluid having the target density and the prescribed crystallization temperature.

Table 6 provides some examples of approximate subatmospheric pressures and boiling temperatures useful for boiling brines having certain atmospheric boiling points: These and similar correlations may be confirmed in published nomographs; for example in an interactive web site of Sigma-Aldrich.

TABLE 6

| | | |
|---|---|---|
| Boiling Point at | Boiling Point at | |
| Atmospheric | Reduced | |
| Pressure | Pressure | Reduced Pressure |

| ° C. | ° F. | ° C. | ° F. | (mmHg |
|---|---|---|---|---|
| 107.22 | 225 | 82.22 | 180 | 371.3 |
| 107.22 | 225 | 87.77 | 190 | 432.5 |
| 107.22 | 225 | 93.33 | 200 | 500 |
| 121.11 | 250 | 82.22 | 180 | 252.5 |
| 121.11 | 250 | 87.77 | 190 | 294.1 |
| 121.11 | 250 | 93.33 | 200 | 357.6 |
| 135 | 275 | 82.22 | 180 | 162.2 |
| 135 | 275 | 87.77 | 190 | 194.2 |
| 135 | 275 | 93.33 | 200 | 230.1 |
| 148.88 | 300 | 85 | 185 | 106.2 |
| 148.88 | 300 | 90.55 | 195 | 137.3 |
| 148.88 | 300 | 96.11 | 205 | 168.4 |
| 162.77 | 325 | 87.77 | 190 | 72.41 |
| 162.77 | 325 | 91.94 | 197.5 | 83.82 |
| 162.77 | 325 | 96.11 | 205 | 100 |
| 176.66 | 350 | 90.55 | 195 | 51.88 |
| 176.66 | 350 | 93.33 | 200 | 56.32 |
| 176.66 | 350 | 96.11 | 205 | 62.49 |
| 190.55 | 375 | 93.33 | 200 | 33.32 |
| 190.55 | 375 | 96.11 | 205 | 36.67 |
| 190.55 | 375 | 98.88 | 210 | 41.87 |

Our invention also includes a method of dewatering a brine-containing oilfield fluid of uncertain composition to minimize the amount of free water therein while maintaining the fluid in a liquid state, the fluid having an original atmospheric boiling point between 213° F. and 370° F., comprising
(a) placing the brine-containing oilfield fluid in a vessel,
(b) boiling water from the brine-containing oilfield fluid to concentrate the brine-containing oilfield fluid in the vessel, thereby increasing its density and also thereby achieving a new boiling point for the fluid thereby concentrated, the new boiling point, expressed as an atmospheric boiling point, being from 10 to 60 degrees F. higher than the original atmospheric boiling point, and

(c) continuously maintaining the concentrated fluid in a liquid state at the new boiling point while continuously withdrawing vapor or steam from the vessel, continuously withdrawing the concentrated fluid from the vessel, and continuously feeding the brine-containing oilfield fluid to the vessel to maintain a substantially constant volume of fluid in the vessel.

In addition, our invention includes a method of concentrating a brine-containing oilfield fluid of uncertain composition to achieve a desired target density TD or greater therein, the desired target density TD being slightly less than the density present at a prescribed crystallization temperature, the fluid having an original atmospheric boiling point between 213° F. and 370° F., comprising
(a) boiling one or more samples of the brine-containing oilfield fluid to achieve higher densities therein and testing said one or more samples to determine a higher density for a sample which, when cooled, will crystallize at a temperature slightly lower than said prescribed crystallization temperature;
(b) designating the density of the higher density sample as the target density TD;
(c) boiling the fluid in a vessel to achieve and maintain the brine at the target density TD or greater while continuously withdrawing vapor or steam from the vessel and continuously feeding the brine-containing oilfield fluid to the vessel to maintain a substantially constant volume of fluid in the vessel, and
(d) continuously withdrawing concentrated fluid of the desired target density TD or greater from the vessel.

Our invention is further described in the following claims.

1. Method of dewatering a brine-containing oilfield fluid of uncertain composition to obtain a densified fluid having a prescribed crystallization temperature, said brine-containing oilfield fluid having an original atmospheric boiling point between 213° F. and 370° F., comprising
(a) empirically determining a target density for said densified fluid,
(b) boiling an initial quantity of said brine-containing oilfield fluid in a vessel at a subatmospheric pressure until said brine-containing oilfield fluid achieves said target density, and
(c) thereafter maintaining substantially steady state temperature and a substantially steady state subatmospheric pressure in said vessel while also maintaining substantially steady state inflow of said brine-containing oilfield fluid and outflow of (i) steam or vapor and (ii) densified fluid having said target density and said prescribed crystallization temperature.

2. Method of claim 1 including preheating said brine-containing oilfield fluid prior to step (b) in at least one of (i) a cavitation device (ii) a heat exchanger transferring heat from said steam or vapor, or (iii) a heat exchanger transferring heat from said densified fluid.

3. Method of claim 1 wherein said densified fluid having said target density and said prescribed crystallization temperature comprises about 1.5% to about 4% by weight free water.

4. Method of claim 1 wherein said substantially steady state temperature of step (c) is at least 75° F. lower than the original atmospheric boiling point of said brine-containing oilfield fluid.

5. Method of claim 1 including, in step (b), continuing to boil said brine-containing oilfield fluid until said brine-containing oilfield fluid achieves a density more dense than said target density, and including diluting said outflow of said densified fluid of step (c) to achieve densified fluid (ii) having said target density and said prescribed crystallization temperature.

6. Method of claim 1 wherein said brine-containing oilfield fluid is a used clear brine having an original atmospheric boiling point between 245° F. and 345° F.

7. Method of claim 1 wherein said brine-containing oilfield fluid is produced water.

8. Method of dewatering a brine-containing oilfield fluid of uncertain composition to minimize the amount of free water therein while maintaining said fluid in a liquid state, said fluid having an original atmospheric boiling point between 213° F. and 370° F., comprising
(a) placing said brine-containing oilfield fluid in a vessel,
(b) boiling water from said brine-containing oilfield fluid to concentrate said brine-containing oilfield fluid in said vessel, thereby increasing its density and also thereby achieving a new boiling point for said fluid thereby concentrated, said new boiling point, expressed as an atmospheric boiling point, being from 10 to 60 degrees F. higher than said original atmospheric boiling point, and
(c) continuously maintaining said concentrated fluid in a liquid state at said new boiling point while continuously withdrawing vapor or steam from said vessel, continuously withdrawing said concentrated fluid from said vessel, and continuously feeding said brine-containing oilfield fluid to said vessel to maintain a substantially constant volume of fluid in said vessel.

9. Method of claim 8 wherein said concentrated fluid withdrawn in step (c) comprises about 1.5% to about 4% by weight free water.

10. Method of claim 8 including conducting step (c) at subatmospheric pressures whereby said new boiling point is reduced to a lower boiling point.

11. Method of claim 8 including preheating said brine-containing oilfield fluid prior to step (b) in at least one of (i) a cavitation device (ii) a heat exchanger transferring heat from said steam or vapor, or (iii) a heat exchanger transferring heat from said concentrated fluid.

12. Method of claim 8 wherein said brine-containing oilfield fluid comprises a used brine.

13. Method of claim 8 wherein said brine-containing oilfield fluid comprises produced water.

14. Method of concentrating a brine-containing oilfield fluid of uncertain composition to achieve a desired target density TD or greater therein, said desired target density TD being slightly less than the density present at a prescribed crystallization temperature, said fluid having an original atmospheric boiling point between 213° F. and 370° F., comprising
(a) boiling one or more samples of said brine-containing oilfield brine to achieve higher densities therein and testing said one or more samples to determine a higher density for a sample which, when cooled, will crystallize at a temperature slightly lower than said prescribed crystallization temperature;
(b) designating the density of said higher density sample as the target density TD;
(c) boiling said fluid in a vessel to achieve and maintain said brine at said target density TD or greater while continuously withdrawing vapor or steam from said vessel and continuously feeding said brine-containing oilfield fluid to said vessel to maintain a substantially constant volume of fluid in said vessel, and
(d) continuously withdrawing concentrated fluid of said desired target density TD or greater from said vessel.

15. Method of claim 14 wherein step (c) is conducted at subatmospheric pressures.

16. Method of claim 15 wherein step (c) is conducted at a temperature at least 50° F. lower than the atmospheric boiling temperature of said fluid.

17. Method of claim 14 wherein said concentrated fluid withdrawn in step (d) comprises about 1.5% to about 4% by weight free water.

18. Method of claim 14 including preheating said brine-containing oilfield fluid prior to step (b) in at least one of (i) a cavitation device (ii) a heat exchanger transferring heat from said steam or vapor, or (iii) a heat exchanger transferring heat from said densified fluid.

19. Method of claim 14 wherein said brine-containing oilfield fluid is a used brine.

20. Method of claim 14 wherein said brine-containing oilfield fluid is produced water.
